(19) United States
(12) Patent Application Publication
(10) Pub. No.: US 2014/0255769 A1
(43) Pub. Date: Sep. 11, 2014

(54) LITHIUM-ION BATTERY ELECTROLYTE INJECTION HOLE SEALING DEVICE

(71) Applicant: Ningde Amperex Technology Limited, Ningde (CN)

(72) Inventors: Huan GAO, Ningde (CN); Chao Yang, Ningde (CN)

(73) Assignee: Ningde Amperex Technology Limited, Ningde (CN)

(21) Appl. No.: 14/195,779

(22) Filed: Mar. 3, 2014

(30) Foreign Application Priority Data
Mar. 8, 2013 (CN) 201320107183.8

(51) Int. Cl. H01M 2/08

(52) U.S. Cl. CPC H01M 2/08
USPC 429/185; 428/131

(57) ABSTRACT

The present disclosure provides a lithium-ion battery electrolyte injection hole sealing device, the lithium-ion battery electrolyte injection hole sealing device is provided with a through hole corresponding to an electrolyte injection hole of a battery cover, the lithium-ion battery electrolyte injection hole sealing device is a film comprising a polypropylene layer, the lithium-ion battery electrolyte injection hole sealing device is packaged on the electrolyte injection hole and a peripheral area of the electrolyte injection hole of the battery cover by hot melting of the polypropylene layer. Consequently, pollution and corrosion of the electrolyte injection hole and the peripheral area thereof are avoided, so as to improve quality of seal welding of the electrolyte injection hole.

### REFERENCE TO RELATED APPLICATIONS

The present application claims priority to Chinese Patent Application No. CN 201320107183.8 filed on Mar. 8, 2013, the content of which is fully incorporated in its entirety herein.

### FIELD OF THE PRESENT DISCLOSURE

The present disclosure relates to lithium-ion battery production field, particularly relates to a lithium-ion battery electrolyte injection hole sealing device.

### BACKGROUND OF THE PRESENT DISCLOSURE

With development of modern society and human energy crisis and environmental issues, people begin to apply lithium-ion batteries to automobile industry to provide driving forces for automobiles by using the lithium-ion batteries, so as to realize zero-emission and zero-pollution.

With wide application of lithium-ion batteries in the automotive industry, people present higher demand on safe reliability of the lithium-ion batteries, namely during automobile running under a variety of road conditions, no electrolyte leakage phenomenon or lithium-ion battery expansion phenomenon appears in the lithium-ion batteries.

However, at present, many lithium-ion batteries for automobiles adopt square or round hard case batteries, such type lithium-ion batteries use electrolyte injection holes as final sealing, the sealing process mainly adopts an advanced laser welding process. In production, during an electrolyte injection process via the electrolyte injection hole and a degassing process via the electrolyte injection hole after formation, there is a certain amount of residual electrolyte at a peripheral area of the electrolyte injection hole, thereby causing certain pollution and corrosion in the peripheral area. In addition, this kind of pollution and corrosion of electrolyte has a strong influence on reliability of quality of laser seal welding of the electrolyte injection hole, thereby easily producing such as air bubble and pinhole unqualified products in the welding process, so as to greatly influence yield rate and reliability of laser seal welding in production. Consequently, the pollution of the electrolyte in the peripheral area of the electrolyte injection hole becomes a major bottleneck in lithium-ion battery production.

### SUMMARY OF THE PRESENT DISCLOSURE

In view of the problem in the background of the present disclosure, an object of the present disclosure is to provide a lithium-ion battery electrolyte injection hole sealing device, which can isolate the electrolyte injection hole and a peripheral area of the electrolyte injection hole from outside, to avoid pollution and corrosion of the electrolyte injection hole and the peripheral area of the electrolyte injection hole.

Another object of the present disclosure is to provide a lithium-ion battery electrolyte injection hole sealing device, which can improve quality of seal welding of the electrolyte injection hole.

In order to achieve the above objects, the present disclosure provides a lithium-ion battery electrolyte injection hole sealing device, the lithium-ion battery electrolyte injection hole sealing device is provided with a through hole corresponding to an electrolyte injection hole of a battery cover, the lithium-ion battery electrolyte injection hole sealing device is a film comprising a polypropylene layer, the lithium-ion battery electrolyte injection hole sealing device is packaged on the electrolyte injection hole and a peripheral area of the electrolyte injection hole of the battery cover by hot melting of the polypropylene layer.

Preferably, the lithium-ion battery electrolyte injection hole sealing device can be stripped off from the electrolyte injection hole and the peripheral area thereof of the battery cover; more preferably, the peripheral area of the electrolyte injection hole where the lithium-ion battery electrolyte injection hole sealing device is packaged by hot melting comprises a seal welding area where the electrolyte injection hole is welded in a sealing manner.

The present disclosure has the following beneficial effects:

The lithium-ion battery electrolyte injection hole sealing device of the present disclosure can isolate the electrolyte injection hole and the peripheral area thereof from outside, to avoid pollution and corrosion of the electrolyte injection hole and the peripheral area thereof.

The lithium-ion battery electrolyte injection hole sealing device can be stripped off and the peripheral area comprises a seal welding area where the electrolyte injection hole is welded in a sealing manner, by which cleanliness and weldability of the seal welding area of the electrolyte injection hole are improved, so as to greatly improve yield rate of seal welding of the electrolyte injection hole and improve reliability quality of battery sealing.

### BRIEF DESCRIPTION OF THE FIGURES

FIG. 1 is a structural schematic view of a lithium-ion battery electrolyte injection hole sealing device which is not packaged by hot melting on the electrolyte injection hole of the battery cover according to the present disclosure;

FIG. 2 is a structural schematic view of a lithium-ion battery electrolyte injection hole sealing device which is packaged by hot melting on the electrolyte injection hole of the battery cover according to the present disclosure;

FIG. 3 is a structural schematic view of an aluminum-plastic film of the lithium-ion battery electrolyte injection hole sealing device according to the present disclosure.

Reference numerals of the embodiments are represented as follows:

1 battery cover
11 electrolyte injection hole

2 electrolyte injection hole sealing device
21 through hole
22 nylon layer
23 aluminum foil layer
24 polypropylene layer

### DETAILED DESCRIPTION

Hereinafter the lithium-ion battery electrolyte injection hole sealing device according to the present disclosure will be illustrated in combination with the drawings.

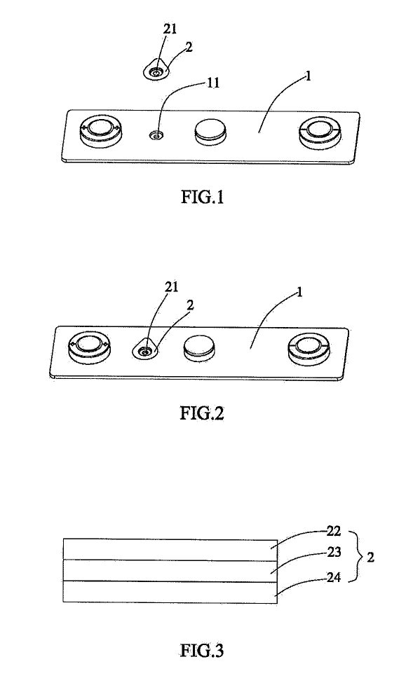

As shown in FIG. 1 to FIG. 3, a lithium-ion battery electrolyte injection hole sealing device 2 according to the present disclosure is provided with a through hole 21 corresponding to an electrolyte injection hole 11 of a battery cover 1, the lithium-ion battery electrolyte injection hole sealing device 2 is a film comprising a polypropylene layer 24, the lithium-ion battery electrolyte injection hole sealing device 2 is packaged on the electrolyte injection hole 11 and a peripheral area of the electrolyte injection hole 1 of the battery cover 1 by hot melting of the polypropylene layer 24. The polypropylene layer 24 is packaged by hot melting on the electrolyte injection hole 11 and the peripheral area thereof, by which pollution and corrosion on the electrolyte injection hole 11 and the peripheral area thereof (such as but not limited to corrosion during an electrolyte injection process and a lithium-ion battery formation degassing process via the electrolyte injection hole 11) can be prevented.

For improving strength, toughness and thermal conductivity in hot melting packaging of the lithium-ion battery electrolyte injection hole sealing device (namely the film) 2, preferably, the lithium-ion battery electrolyte injection hole sealing device (namely the film) 2 may further comprise an aluminum foil layer 23 and a nylon layer 22 laminated on the polypropylene layer 24, the film formed by the outer nylon layer 22, the intermediate aluminum foil layer 23 and the inner polypropylene layer 24 is an aluminum-plastic film. The aluminum foil layer 23 not only improves strength and toughness of the film, but also improves thermal conductivity and thermal distribution uniformity in hot melting packaging of the polypropylene layer 24, so as to improve quality and efficiency of packaging by hot melting. In addition, the aluminum-plastic film has good strength, toughness, weathering resistance and electrolyte resistance, so as to be more reliably applied to the electrolyte injection process and the lithium-ion battery formation degassing process via the electrolyte injection hole 11. In addition, when stripping function described later is involved, the lithium-ion battery electrolyte injection hole sealing device 2 can be easily and entirely stripped off due to the aluminum-plastic film with the improved strength thereof.

Preferably, a thickness of the nylon layer 22 is 5˜15 μm. Preferably, a thickness of the aluminum foil layer 23 is 5˜15 μm. Preferably, a thickness of the polypropylene layer 24 is 5˜15 μm.

In the lithium-ion battery electrolyte injection hole sealing device 2 according to the present disclosure, preferably, the lithium-ion battery electrolyte injection hole sealing device 2 can be stripped off from the electrolyte injection hole 11 and the peripheral area of the electrolyte injection hole 11 of the battery cover 1. For improving quality of seal welding of the electrolyte injection hole 11 (for example eliminating unqualified qualities, such as air bubble and pinhole and the like), more preferably, the peripheral area of the electrolyte injection hole 11 where the lithium-ion battery electrolyte injection hole sealing device 2 is packaged by hot melting comprises a seal welding area where the electrolyte injection hole 11 is welded in a sealing manner. The lithium-ion battery electrolyte injection hole sealing device 2 is stripped off after protecting function is finished, so as to weld the electrolyte injection hole 11 in a sealing manner (for example with laser seal welding).

Hereinafter an operation process of the lithium-ion battery electrolyte injection hole sealing device 2 will be briefly described in combination with all embodiments with features in FIG. 1 to FIG. 3.

Firstly a lithium-ion battery electrolyte injection hole sealing device 2 made by the aluminum-plastic film and a clean battery cover 1 without any pollution is prepared; then the through hole 21 of the lithium-ion battery electrolyte injection hole sealing device 2 is aligned with the electrolyte injection hole 11, followed by tightly being pressed by a hot sealing head to allow the inner polypropylene layer 24 of the aluminum-plastic film to melt and closely integrate with a wall of the electrolyte injection hole 21 of the battery cover 1 and a surface of the battery cover 1 positioned at the periphery of the electrolyte injection hole 21, so as to finish the packaging process.

After all processes in which the electrolyte is possibly contacted with are finished, the lithium-ion battery electrolyte injection hole sealing device 2 can be stripped off according to actual requirements, a nail sealer or a ball sealer is mounted on the electrolyte injection hole 11, finally laser seal welding is performed to subject the battery to final sealing.

What is claimed is:

1. A lithium-ion battery electrolyte injection hole sealing device (2),
the lithium-ion battery electrolyte injection hole sealing device (2) being provided with a through hole (21) corresponding to an electrolyte injection hole (11) of a battery cover (1);
the lithium-ion battery electrolyte injection hole sealing device (2) being a film comprising a polypropylene layer (24), the lithium-ion battery electrolyte injection hole sealing device (2) being packaged on the electrolyte injection hole (11) and a peripheral area of the electrolyte injection hole (11) of the battery cover (1) by hot melting of the polypropylene layer (24).

2. The lithium-ion battery electrolyte injection hole sealing device (2) according to claim 1, wherein the lithium-ion battery electrolyte injection hole sealing device (2) further comprises an aluminum foil layer (23) and a nylon layer (22) sequentially laminated on the polypropylene layer (24).

3. The lithium-ion battery electrolyte injection hole sealing device (2) according to claim 2, wherein a thickness of the nylon layer (22) is 5˜15 μm.

4. The lithium-ion battery electrolyte injection hole sealing device (2) according to claim 2, wherein a thickness of the aluminum foil layer (23) is 5˜15 μm.

5. The lithium-ion battery electrolyte injection hole sealing device (2) according to claim 1, wherein a thickness of the polypropylene layer (24) is 5˜15 μm.

6. The lithium-ion battery electrolyte injection hole sealing device (2) according to claim 1, wherein the lithium-ion battery electrolyte injection hole sealing device (2) can be stripped off from the electrolyte injection hole (11) and the peripheral area thereof of the battery cover (1).

7. The lithium-ion battery electrolyte injection hole sealing device (2) according to claim 6, wherein the peripheral area of the electrolyte injection hole (11) where the lithium-ion battery electrolyte injection hole sealing device (2) is packaged by hot melting comprises a seal welding area where the electrolyte injection hole (11) is welded in a sealing manner.
